(19) United States
(12) Patent Application Publication
(10) Pub. No.: US 2020/0372551 A1
(43) Pub. Date: Nov. 26, 2020

(54) DIVERSITY-BASED SYSTEM FOR ADMINISTRATION OF CHARITABLE TRUST

(71) Applicant: Bank of America Corporation, Charlotte, NC (US)

(72) Inventors: Richard S. Scot, Huntersville, NC (US); Cheyenne Cochrane, West Springfield, VA (US); Rebecca Gibbs Staton, Huntersville, NC (US); Peter Nein, Waxhaw, NC (US); Edward A. Rhodes, Los Angeles, CA (US); Manu Kurian, Dallas, TX (US)

(21) Appl. No.: 16/417,782

(22) Filed: May 21, 2019

(51) Int. Cl. G06Q 30/02; G06Q 20/38; G06Q 20/40; G06F 16/23

(52) U.S. Cl. CPC G06Q 30/0279; G06Q 20/389; G06F 16/2365; G06Q 30/0282; G06Q 20/40

(57) ABSTRACT

A method for donating to a charitable organization from a digital donation platform is provided. The method may include identifying a digital transmission from the charitable organization including a request for a donation of funds. The method may include creating a digital account for the charitable organization. The method may include assigning a score for the charitable organization based on a diversity of employees in the organization. When the score is equal to or above a pre-determined threshold, the method may include assigning one of a first tier of digital portals to the charitable organization including a first level of platform oversight over the funds being transferred. When the score is below the pre-determined threshold, the method may include assigning one of a second tier of digital portals to the charitable organization including a second level of platform oversight over the funds being transferred.

### FIELD OF TECHNOLOGY

Aspects of the disclosure relate to digital platforms. Specifically, aspects of the disclosure relate to diversity-based digital platforms for administering charitable donations.

### BACKGROUND OF THE DISCLOSURE

All companies value the importance of diversity and inclusion in the workforce. Companies may include large corporations, small corporations as well as individuals. These companies may interview people with top talent and diverse ethnicities and backgrounds, and hire them for careers throughout the company. It is commonly accepted practice not to, and in fact, employers may not legally, limit their intake of employees to a specific race, ethnicity, gender, age, social class, physical ability or attributes, religious or ethical values system, national origin, and/or political beliefs.

Often the companies commit to a practice of corporate philanthropy and wish to donate to charitable organizations that align with the core values of its company. These companies may desire to distribute their charity to charitable organizations that value diversity and inclusion within their organizations and within recipients of the charitable organizations.

It would be desirable to provide the companies with systems and methods for screening charitable organizations to maintain diversity as a value of the companies.

### SUMMARY OF THE DISCLOSURE

Aspects of the disclosure relate to a method for donating to a charitable organization from a digital donation platform. The method may be executed by computer code stored in a non-transitory memory and running on a processor. The method may include identifying a digital transmission comprising a request. The request may be a request for a donation from the charitable organization. The request may include a request for funds for charity.

The method may also include creating a digital account for the charitable organization. The digital account may be configured to retain temporarily the donation to be transferred to the charitable organization.

The method may further include assigning a score for the charitable organization using a rating-metric. The score may be based on a diversity of employees in the organization. The score may also be based on a diversity of the recipients of the charitable organizations funds.

The method may also include configuring a plurality of digital portals. Each of the plurality of digital portals may be configured to provide a level of oversight over a value of funds being transferred to the charitable organization. The levels of oversight may include a first tier of portals with a first level of oversight. The first tier of portals may be configured to conduct a pre-scan of recipients selected by the charitable organization to receive the donation. Upon retrieval of the donation from the digital account, the method may include tracking the donation as it is transferred from the digital account to the selected recipient(s).

A second tier of portals may be included within the plurality of digital portals. The second tier may provide a second level of oversight. The second tier of portals may be configured to track the donation as it is transferred from the digital account to the selected recipients.

Following configuration of the portal, the method may include assigning a first or second tier of portals to the charitable organization. One of the first tiers of digital portals may be assigned to the charitable organization when the score is equal to or above a pre-determined threshold. One of the second tiers of digital portals may be assigned to the charitable organization when the score is below the pre-determined threshold.

The method may further include structuring a transaction by compiling the donation for the charitable organization and transferring funds from the platform to the digital account associated with the charitable organization. The funds may reflect, at least in part, the request and the score.

When the transaction is authorized, the method may further include transferring funds from the digital account to the charitable organization and updating a database to record the transfer.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative architecture in accordance with principles of the disclosure.

FIG. 2 shows an illustrative flowchart in accordance with principles of the disclosure.

FIG. 3 shows another illustrative flowchart in accordance with principles of the disclosure.

FIG. 4 shows an illustrative diagram in accordance with principles of the disclosure.

FIG. 5 shows another illustrative diagram in accordance with principles of the disclosure.

FIG. 6 shows an illustrative system in accordance with principles of the disclosure.

FIG. 7 shows another illustrative system in accordance with principles of the disclosure.

### DETAILED DESCRIPTION OF THE DISCLOSURE

A charitable donation platform is provided. The platform may be a digital platform that includes computer executable instructions that are stored in non-transitory memory and run on a processor. The platform may run on a server. The platform may run on a “cloud.” The platform may be accessible, online or via any suitable network, by other remote servers or computing devices.

The platform may include a database. The database may be configured to store a plurality of donations. The database may be configured to store a plurality of charitable organizations. Each donation may include a monetary value and being associated with one of the charitable organizations. The associated organization may be an organization to which the donation is to be transferred.

The platform may also include a plurality of digital accounts. Each digital account may be associated with one of the charitable organizations. Each digital account may be configured to retain temporarily one of the plurality of donations transferred to the charitable organization.

The platform may also include a plurality of digital portals. Each digital portal may be associated with one of the plurality of charitable organizations. Each digital portal may be linked to one of the digital accounts. Each digital portal may provide a level of oversight. The level of oversight may be based on rules-based restrictions on the use of funds held in the digital account. The oversight may be a platform oversight.

The platform may be configured with a hierarchical architecture. The hierarchical architecture may include multiple sets, or tiers, of the digital portals. The multiple tiers may be associated with varying levels of platform oversight.

The hierarchical architecture may be configured such that the levels of oversight include a first tier of digital portals, a second-tier of digital portals and a third tier of digital portals. The first tier of digital portals may be configured to provide a first-level of oversight over the donation being transferred. The first-level of oversight may include, prior to transferring the donation from the digital account to the organization, conducting a pre-scan of recipients selected by the charitable organization to receive the donation. The first-level of oversight may further include, following the transfer of the donation, tracking the donation retrieved from the digital account as it is transferred to the recipients.

In some embodiments, the first-level of oversight may include, pre-selecting, via the platform, a one or more sub-charities associated with the charitable organization to receive the donation.

The second tier of digital portals may be configured to provide a second-level control of the received donation. The second-level control may include tracking the donation retrieved from the digital account as it is transferred to the recipients selected by the charitable organization.

The third tier of digital portals may be configured to provide a third-level of oversight over the donation being transferred. The third-level of oversight may provide the charitable organization with unrestricted access to the funds in the digital account.

The platform may be configured to identify a request for a donation from one of the charitable organizations. The request may include a request for funds for charity.

The request may be for a donation directed to the charitable organization itself. The request may be for a donation directed to a secondary charity associated with the charitable organization. The charitable organization may be an umbrella organization that provides charity, financial assistance, and other resources to smaller organizations. A request for a donation may include an actual transfer of funds to the charitable organization, e.g., cash, check, cryptocurrency, or any other material of value (food, clothing, supplies, etc.). The funds may be stored in a funds account, trust, or any other suitable safekeeping mechanism.

In some embodiments, the request for a donation from a charitable organization may be a request to sponsor an event i.e.—a fair, a conference, a series of workshops and any other form of activity that may be associated with the charitable organization. The request may be to host the event. The request may be to sponsor the event.

The platform, in response to the request, may be configured to analyze the charitable organization. The analyzing may be for verifying the authenticity of the organization. The analyzing may further be for determining a level of diversity within the organization's population and within the secondary charities associated with the organization's population.

The platform may determine a score for the charitable organization using a rating-metric. The platform may be configured to determine the score by rating the level of diversity within the charitable organization. The score may be based on a diversity of employees in the organization. The score may be based on the diversity of the recipients of the charitable organizations funds. The score may be proportional to a variety metric associated with a diversity in the backgrounds within the charitable organization's population.

In some embodiments the score may be calculated based on information received from the charitable organization. The platform may provide a questionnaire to the charitable organization. The questionnaire may include questions associated with background information of the employees working in the organization. The questions may also be related to questions associated with charities linked to the organization. Based on the answers received to the questions, the platform may score the percentage of diversity within the charitable organization.

In other embodiments the score may be calculated based on data received from publicly available resources i.e.—the internet. The platform may access publicly available social media accounts associated with the employees of the organization and determine employee background information that may imply diversity. The platform may be accessing the publicly available resources to find data associated with the specific race, ethnicity, gender, age, social class, physical ability or attributes, religious or ethical values system, national origin, and/or political beliefs of the employees and/or of secondary recipients that may receive charity from the charitable organization. The more variety determined within the aforementioned examples of the organization's population, the greater the assigned score.

Furthermore, the donation platform may implement artificial intelligence (“AI”) to scrape the publicly available databases for data that may assist in determining the level of diversity within the charitable organization. The platform may combine the data received and perform a calculation based on the data and one or more pre-determined thresholds to determine the score.

The platform may be configured to assign a first, second or third tier of digital portals to the charitable organization based on the determined score. The platform may be configured to assign a one of the first tier of digital portals to the charitable organization when the score is equal to or above a pre-determined threshold. The platform may be configured to assign a one of the second tier of digital portals to the charitable organization when the score is below the pre-determined threshold. The platform may be configured to assign a one of the third tier of digital portals to the charitable organization when the score is equal to a pre-determined maximum score.

Following the assigning of the digital portal, the platform may be configured to process the request. The platform may be configured to structure a transaction by compiling the donation for the charitable organization and transferring the funds from the platform to the digital account associated with the charitable organization. The funds may reflect, at least in part, the request and the score. The charitable donation platform may provide an amount of funds greater than the requested amount of funds when the charitable organizations score is greater than the pre-determined threshold level.

Structuring the transaction may entail setting up the transfer, i.e., allocating select funds to be transferred to a select cause. In some embodiments, the structuring may be performed automatically via a processor within the platform. The transaction may include a transfer of funds to a charitable organization.

Following the structuring of the transaction, the platform may be configured to authorize the transaction. In response to the authorization, the funds may be transferred from the digital account to the charitable organization. The platform may then be configured to update the database to record the transfer. The requested amount of funds and identification information of the charitable organization may be recorded on the database. Furthermore, the amount of funds transferred to the organization and the digital portal assigned to the organization may also be recorded on the database.

The database may, in some embodiments, be blockchain-based. The blockchain may include a distributed ledger of electronic data records. Each record may be authenticated by a consensus protocol. A complete copy of the blockchain may be stored on multiple computer systems. Each computer system that stores a copy of the blockchain may be a “node.”

Groups of authenticated transactions may be gathered into “blocks.” Each block may include data and metadata. Metadata may include a reference to the previous block in the chain and a unique identifier associated with the previous block. The unique identifier may be an output of a hash function.

A node may add a block to the blockchain. However, the block may only become part of the blockchain when a quorum—i.e., a predetermined number or percentage—of nodes independently verify and authenticate the transactions set forth in the block. A “consensus” may then be reached to add the block to each copy of the blockchain. Using a blockchain for the platform may leverage the decentralized nature of blockchains to provide transparency and built-in verification in tracking and managing donations in the platform.

For example, when the database is implemented as a blockchain, updating the database may include adding a block to the blockchain.

A blockchain database may, in general, include a plurality of nodes. In some embodiments of the platform, the plurality of nodes may include computer systems associated with a plurality of donors. For example, in some embodiments, each donor may be associated with a computer system that is a node. In some cases, the computer system may also provide access for the donor to the digital portal.

In some embodiments, nodes may also include computer systems associated with the plurality of charitable organizations, non-donors, such as a board of trustees or administrators of the donation platform, or any other suitable member of the general public.

In certain embodiments, following the transfer of funds to the charitable organization, the platform may be configured to periodically perform an analysis on the diversity of employees in the organization. The platform may be configured to periodically perform an analysis on the diversity of the recipients of the charitable organizations funds. This periodic analysis may be performed in order to monitor for any change that may change the score of the organization and may affect a future donation of funds to the organization.

The platform may be further configured to adjust the score of the charitable organization based on the periodic performance of the analysis. In the event of a change in the score, the platform may be further configured to change the allocation of the digital portal for the charitable organization for a subsequent request of a donation from the charitable organization. The periodic performance may be enabled via AI.

In some embodiments, the platform may provide end-to-end tracking even when the level of oversight is at the third level. This may be an option selected by the organization as a preference. For example, the donation may be recorded on the database, e.g., a blockchain. The platform may route the funds to the charitable organization according to the disclosed systems and methods, recording the transfer to the blockchain. When the organization may disburse the funds to one or more recipients associated with the organization, the disbursement may also be recorded on the blockchain. In some embodiments, disbursements of funds may be validated and recorded by storing photo and/or video records of the disbursement on the database, e.g., the blockchain. The platform may thereby be providing complete end-to-end tracking of the flow of the donated funds until they actually reach the possession of the selected/requested recipient(s).

In another embodiment, a diversity-based charitable donation system for administration of charitable trust is provided. The system may include a receiver. The receiver may be configured to identify a request for a donation from one of a plurality of charitable organizations. The request may include a request for funds for charity.

The system may also include a processor. The processor may be configured to determine a score for the charitable organization using a rating-metric. The score may be based on a level of diversity within the employees in the organization and a level of diversity within the recipients of the charitable organizations funds.

The processor, in response to the request, may also be configured to create a digital account for the charitable organization. The digital account may be associated with the charitable organization and may be configured to retain, temporarily, the funds being transferred to the charitable organization.

The processor may further be configured to assign a digital portal from a plurality of digital portals for the charitable organization. The assigned digital portal may be based on the score. Each digital portal may be associated with one of the plurality of charitable organizations. Each digital portal may be linked to the digital account. Each digital portal may provide rules-based restrictions on a use of funds held in the digital account. The restrictions may include different levels of oversight via the platform of the funds being held in the digital account. A first level of oversight may be provided by the first tier of digital portals. A second level of oversight may be provided by the second tier of digital portals. A third level of oversight may be provided by the third tier of digital portals.

Following assigning a digital portal to the organization, the processor may be configured to structure a transaction by compiling a donation for the charitable organization and transferring the funds from the platform to the digital account associated with the charitable organization. The funds may reflect, at least in part, the request and the score.

When the transaction is authorized via the digital portal linked to the charitable account, the processor may be further configured to transfer funds from the digital account to the charitable organization and record the donation and the associated charitable organization on a database.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

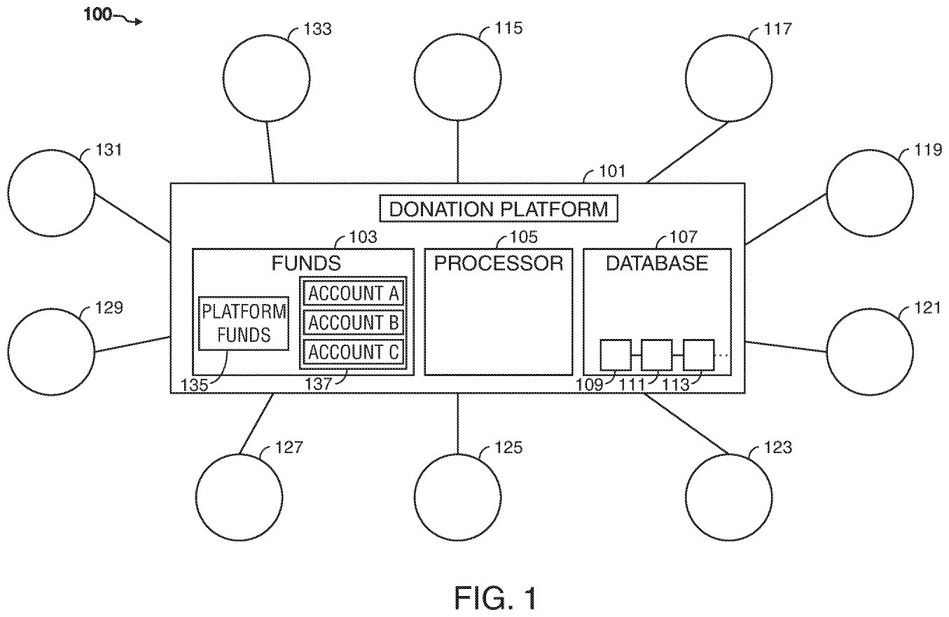

FIG. 1 shows an architectural diagram of illustrative system 100 according to aspects of the disclosure. System 100 may include donation platform 101. Donation platform 101 may include a funds module 103, a processor 105, and a database 107.

Funds module 103 may be any suitable module for storing funds—or other items of value being donated to charitable organizations. For example, funds module 103 may be an account at a financial institution. Funds module 103 may be a database for storing account or payment instrument information. Funds module 103 may also include a safe, warehouse, or other storage facility suitable for storing items of value.

Funds module 103 may be suitable to store all the funds received at the donation platform 101. Funds module 103 may include a first storage area for all donations at 135. Funds module 103 may also include a second storage for storing donations already allocated to a specific charitable organization. Each organization may have a unique digital account to retain temporarily the funds being transferred to the organization.

Database 107 may be any suitable database for storing donation data. In some embodiments, database 107 may be implemented as a blockchain, including blocks 109-113.

System 100 may include portals 115-133. Each portal may be associated with a charitable organization, and may provide the platform oversight over the donation being transferred to the charitable organization. Furthermore, each portal may be configured with rules-based restrictions defining a level of platform oversight over the donations being transferred to the charitable organizations. Each portal may have a different level of platform oversight.

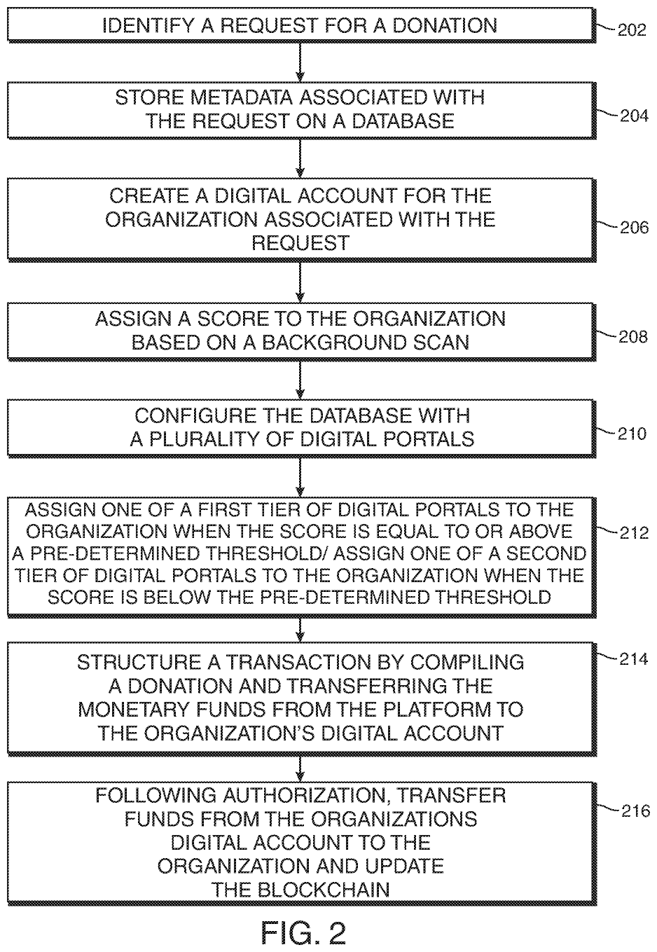

FIG. 2 shows an illustrative flowchart in accordance with principles of the disclosure. At step 202, a system may identify a request for a donation. The donation may include an amount of funds for charity. The request may be received from a charitable organization. At step 204, the system may store metadata associated with the request on a database.

At step 206, the system may create a digital account for the organization associated with the request. At step 208, the system may assign a score to the organization based on a background-scan of the organization. The background-scan may include analyzing the organization to determine a level of diversity within the organization's population and within the secondary charities associated with the organization's population. At step 210, the system may configure the database with a plurality of digital portals for the organization. At step 212, the system may assign one of the plurality of digital portals for the organization. The assigned portal may be selected based on the score assigned to the organization.

At step 214, the system may structure a transaction by compiling a donation and transferring the funds from the donation platform to the organization's digital account.

At step 216, the system may authorize the transaction. The system may further transfer funds from the organization's digital account to the organization and update the database to record the transfer.

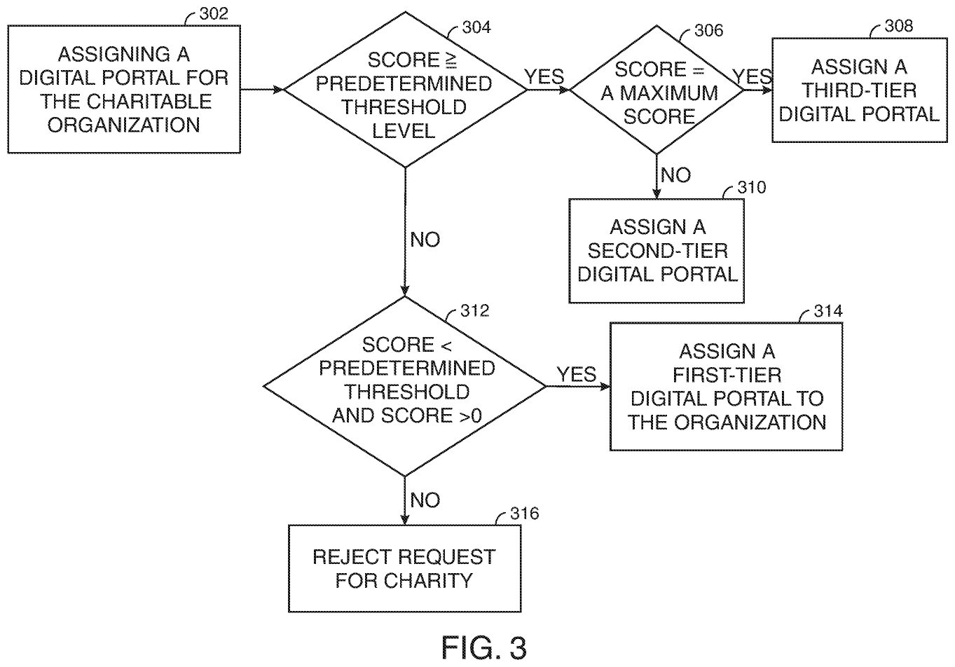

FIG. 3 shows another illustrative flowchart in accordance with principles of the disclosure. The score assigned to the organization may be based on the level of diversity within the charitable organization, as shown at step 302. An organization that includes a more diverse group of employees and also respects and donates to secondary charities that are diverse and/or incorporate diversity, may have a greater score. A higher score may enable the organization a higher level of control over the donations from the system.

At step 304 the score may be analyzed using a rating metric. The metric may start at the number zero and end at the number 10. A pre-determined threshold level may be set to the number 5. If the score is greater than or equal to the pre-determined threshold level, step 306 may be performed. At step 306 the score may be checked to determine if it is equal to the maximum score of 10. When the score is lower than the maximum score, the organization is assigned the second tier digital portal, as shown at step 310. The second tier digital portal may provide the organization access to the funds without having to provide the platform with pre-selected list of recipients. The second tier may provide a second level of access where the donation is being tracked as it is transferred from the digital account to the charitable organization.

When the score is equal to the maximum score, step 308 may assign a third-tier digital portal to the charitable organization. The third tier digital portal may provide a third level of oversight. The third level enables the organization unrestricted access to the funds being held in the organizations digital account.

Following step 304, when the score is less than the pre-determined threshold level, the system is configured to check if the score is greater than zero, as shown at step 312. When the score is equal to zero, the request for the donation is rejected as shown at step 316. The request may be deleted from the system and a communication message is transmitted to the organization.

Following step 312, when the score is greater than zero and less than the pre-determined threshold level, a first tier digital portal may be assigned to the charitable organization, as shown at step 314. The first-tier provides a first level of oversight where the organization may have to pre-select the recipients who may receive the donation and provide the selected recipients to the system for a pre-scan on a level of diversity within the recipients. Following approval of the selected recipients, the system may further track the donation as it is transferred from the digital account associated with the organization to the recipients selected by the organization.

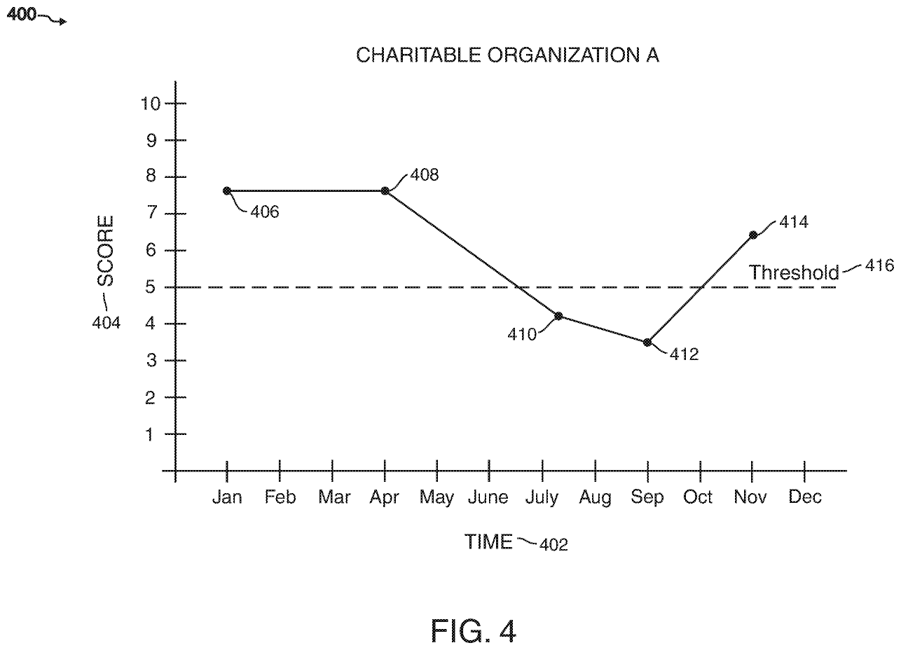

FIG. 4 shows an illustrative diagram of a graph 400 displaying a periodic scanning of a charitable organization's population over a period of time. The horizontal axis 402 displays the time over 12 months of a year. The vertical axis 404 displays the score assigned to the charitable organization. In this exemplary graph, charitable organization A may have requested a donation in January. The system may have assigned a score of 8 to the organization, as shown at 406. In accordance with principles of the disclosure, the charitable organization's score in January is above the pre-determined threshold level 416. The organization may have been assigned a second tier digital portal linked to the digital account. The system may have transferred an amount of funds greater than the requested funds since the organization has a high percentage of diversity within the organization's population.

Following the initial donation in January, the system may periodically scan the percentage of diversity within charitable organization A's population. When the percentage increases or decreases, the digital portal and the amount of funds donated to the organization for a subsequent request of a donation from the organization may need to be adjusted.

As shown in graph 400, a subsequent request from the organization may have been identified in March, as shown at 408. The score did not change and adjustments within the platform for the organization may not be necessary.

Another request for a donation may have been received from charitable organization A in July. Following scanning the organization's population, the score may need to be adjusted and may now be below the pre-determined threshold 416 as shown at 410. The digital portal may need to be adjusted and the amount of funds transferred may differ from the requested amounts of funds. This may be based on the change in the score assigned to the charitable organization.

Charitable organization A may submit another request in September. Following scanning the organization's population, the organization may be assigned a score of 3.5, as shown at 412. This may be lower than the score in July as a change in the level of diversity may have been determined.

Subsequently, a request may be received in December from charitable organization A. The system may scan the available resources and determine a significant increase in the level of diversity within the organization. This may be compared to the level determined in September, as shown at 412. The system may be configured to increase the score significantly, as shown at 414. The score may now be above the pre-determined threshold 416 and an adjustment to the digital portal may be performed. Furthermore, the amount of funds donated may increase as well.

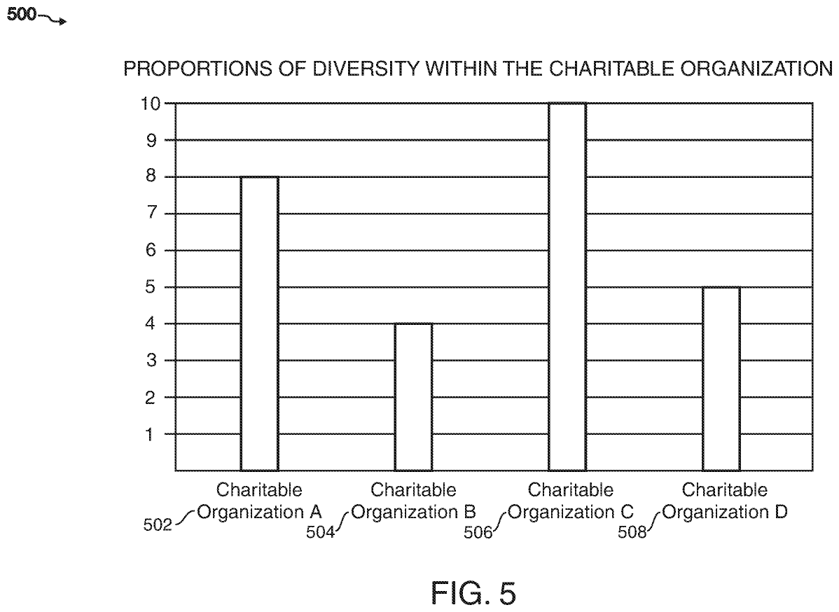

FIG. 5 is a bar graph 500 that shows proportions of diversity within a plurality of charitable organizations.

Charitable organization A, at 502, may have been assigned a score of 8. The score may be above the pre-determined threshold. Charitable organization B, at 504, may be assigned a score of 4. The score may be below the pre-determined threshold. Charitable organization C, at 506, may be assigned the maximum score of 10. Charitable organization D, at 508, may be assigned a score of 5. The score of 5 may be at the pre-determined threshold level.

Each of the organizations may receive a unique score and may be assigned a first, second or third tier digital portal based on the score. Furthermore, the amount of funds donated to the charitable organization may be increased or decreased based on the score.

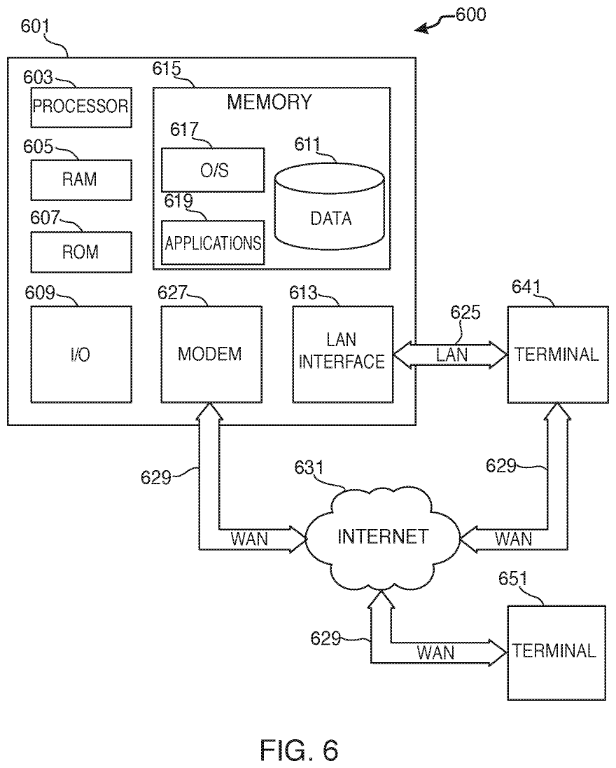

FIG. 6 shows an illustrative block diagram of system 600 that includes computer 601. Computer 601 may alternatively be referred to herein as a “server” or a “computing device.” Computer 601 may be a desktop, laptop, tablet, smart phone, or any other suitable computing device. Elements of system 600, including computer 601, may be used to implement various aspects of the systems and methods disclosed herein.

Computer 601 may have a processor 603 for controlling the operation of the device and its associated components, and may include RAM 605, ROM 607, input/output module 609, and a memory 615. The processor 603 may also execute all software running on the computer—e.g., the operating system and/or voice recognition software. Other components commonly used for computers, such as EEPROM or Flash memory or any other suitable components, may also be part of the computer 601.

The memory 615 may be comprised of any suitable permanent storage technology—e.g., a hard drive. The memory 615 may store software including the operating system 617 and application(s) 619 along with any data 611 needed for the operation of the system 600. Memory 615 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 501 may execute the instructions embodied by the software to perform various functions.

Input/output (“I/O”) module may include connectivity to a microphone, keyboard, touch screen, mouse, and/or stylus through which a user of computer 601 may provide input. The input may include input relating to cursor movement. The input may relate to transmitting, tracking, authorizing, and/or controlling charitable donations. The input/output module may also include one or more speakers for providing audio output and a video display device for providing textual, audio, audiovisual, and/or graphical output. The input and output may be related to computer application functionality.

System 600 may be connected to other systems via a local area network (LAN) interface 613.

System 600 may operate in a networked environment supporting connections to one or more remote computers, such as terminals 641 and 651. Terminals 641 and 651 may be personal computers or servers that include many or all of the elements described above relative to system 600. The network connections depicted in FIG. 6 include a local area network (LAN) 625 and a wide area network (WAN) 629, but may also include other networks. When used in a LAN networking environment, computer 601 is connected to LAN 625 through a LAN interface or adapter 613. When used in a WAN networking environment, computer 601 may include a modem 627 or other means for establishing communications over WAN 629, such as Internet 631.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server.

The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory. The transmission of the data together with computer-readable instructions may enable the computer system to quickly retrieve the data, when needed. Because the computer system is able to quickly retrieve the data, the web-based server may not need to stream the data to the computer system. This may be beneficial for the computer system, because the retrieval may be faster than data-streaming. Conventionally, streaming data requires heavy usage of the processor and the cache memory. If the data is stored in the computer system's memory, retrieval of the data may not require heavy processor and cache memory usage. Any of various conventional web browsers can be used to display and manipulate retrieved data on web pages.

Additionally, application program(s) 619, which may be used by computer 101, may include computer executable instructions for invoking user functionality related to communication, such as e-mail, Short Message Service (SMS), and voice input and speech recognition applications. Application program(s) 619 (which may be alternatively referred to herein as “plugins,” “applications,” or “apps”) may include computer executable instructions for invoking user functionality related performing various tasks. The various tasks may be related to transmitting, tracking, authorizing, and/or controlling charitable donations.

Computer 601 and/or terminals 641 and 651 may also be devices including various other components, such as a battery, speaker, and/or antennas (not shown).

Terminal 651 and/or terminal 641 may be portable devices such as a laptop, cell phone, Blackberry™, tablet, smartphone, or any other suitable device for receiving, storing, transmitting and/or displaying relevant information. Terminals 651 and/or terminal 641 may be other devices. These devices may be identical to system 600 or different. The differences may be related to hardware components and/or software components.

Any information described above in connection with database 611, and any other suitable information, may be stored in memory 615. One or more of applications 619 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

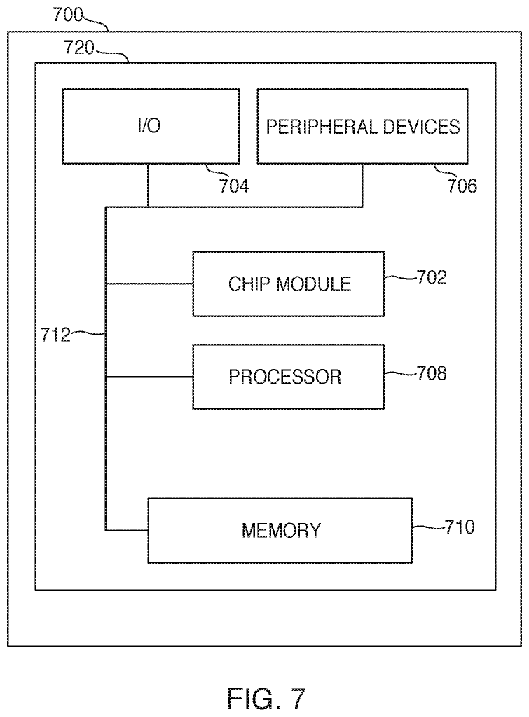

FIG. 7 shows illustrative apparatus 700 that may be configured in accordance with the principles of the disclosure. Apparatus 700 may be a computing machine. Apparatus 700 may include one or more features of the apparatus shown in FIG. 1. Apparatus 700 may include chip module 702, which may include one or more integrated circuits, and which may include logic configured to perform any other suitable logical operations.

Apparatus 700 may include one or more of the following components: I/O circuitry 704, which may include a transmitter device and a receiver device and may interface with fiber optic cable, coaxial cable, telephone lines, wireless devices, PHY layer hardware, a keypad/display control device or any other suitable media or devices; peripheral devices 706, which may include counter timers, real-time timers, power-on reset generators or any other suitable peripheral devices; logical processing device 708, which may compute data structural information and structural parameters of the data; and machine-readable memory 710.

Machine-readable memory 710 may be configured to store in machine-readable data structures: machine executable instructions (which may be alternatively referred to herein as “computer instructions” or “computer code”), applications, signals, and/or any other suitable information or data structures.

Components 702, 704, 706, 708 and 710 may be coupled together by a system bus or other interconnections 712 and may be present on one or more circuit boards such as 720. In some embodiments, the components may be integrated into a single chip. The chip may be silicon-based.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and apparatus for a diversity based system for the administration of charitable trust are provided. Persons skilled in the art will appreciate that the present invention can be practiced by other than the described embodiments, which are presented for purposes of illustration rather than of limitation, and that the present invention is limited only by the claims that follow.

1-9. (canceled)

10. A diversity-based charitable donation system for administration of charitable trust, the system comprising:
a receiver configured to identify a request for a donation from one of a plurality of charitable organizations, the request including a request for funds for charity;
a processor configured to:
determine a score for the charitable organization using a rating-metric, the score being based on a diversity of employees in the organization and on a diversity of the recipients of the charitable organizations funds;
create a digital account for the charitable organization, the digital account being associated with the charitable organization and being configured to retain temporarily the funds being transferred to the charitable organization;
assign a digital portal from a plurality of digital portals for the charitable organization, the assigned digital portal being based on the score, each digital portal being associated with one of the plurality of charitable organizations and being linked to a digital account, each digital portal providing a level of oversight of the funds being held in the digital account, wherein the system is configured with:
a first tier of digital portals configured to provide a first-level of oversight over the donation being transferred, the first-level of oversight comprising, prior to transferring the donation from the digital account to the organization, conducting a pre-scan of recipients selected by the charitable organization to receive the donation and following the transfer of the donation, tracking the donation retrieved from the digital account as it is transferred to the selected sub-charities; and
a second tier of digital portals configured to provide a second-level control of the received donation, the second-level control comprising tracking the donation as it is transferred from the digital account to recipients selected by the charitable organization to receive the donation;
structure a transaction by compiling a donation for the charitable organization and transferring the funds from the platform to the digital account associated with the charitable organization, the funds reflecting, at least in part, the request and the score; and
when the transaction is authorized via the digital portal linked to the charitable account, the processor is further configured to:
transfer the funds from the digital account to the charitable organization; and
record the donation and the associated charitable organization on a database.

11. The system of claim 10 wherein the plurality of digital portals further comprise a third tier of digital portals that are configured to provide a third-level of oversight over the donation being transferred, the third-level of oversight that provides the charitable organization with unrestricted access to the funds.

12. The system of claim 10 wherein the processor is configured to increase the score when a level of the diversity of employees in the organization and/or a level of the diversity of the recipients of the charitable organizations funds is at or above a pre-determined threshold level and decrease the score when the level of the diversity of employees in the organization and/or the level of the diversity of the recipients of the charitable organizations funds is below the pre-determined threshold level.

13. A method for donating to a charitable organization from a digital donation platform, the method executed by computer code stored in a non-transitory memory and running on a processor, the method comprising:
identifying a digital transmission comprising a request for a donation from the charitable organization, the request including a request for funds for charity;
creating a digital account for the charitable organization, the digital account configured to retain temporarily the donation to be transferred to the charitable organization;
assigning a score for the charitable organization using a rating-metric, the score being based on a diversity of employees in the organization and on a diversity of the recipients of the charitable organizations funds;
configuring a plurality of tiers of digital portals, each of the plurality of tiers of digital portals configured to provide a level of oversight of the funds being held in the digital account, the plurality of tiers comprising:
a first tier of portals with a first level of oversight configured to conduct a pre-scan of recipients selected by the charitable organization to receive the donation and upon retrieval of the donation from the digital account, track the donation as it is transferred from the digital account to the selected recipients;
a second tier of portals with a second level of oversight configured to track the donation retrieved as it is transferred from the digital account to the selected recipients;
when the score is equal to or above a pre-determined threshold, assigning a one of the first tier of digital portals to the charitable organization;
when the score is below the pre-determined threshold, assigning a one of the second tier of digital portals to the charitable organization;
structuring a transaction by compiling the donation for the charitable organization and transferring the funds from the platform to the digital account associated with the charitable organization, the funds reflecting at least in part the request and the score; and
when the transaction is authorized, the method further comprises:
transferring the funds from the digital account to the charitable organization; and
updating a database to record the transfer.

14. The method of claim 13 wherein the score is proportional to a variety in the backgrounds within the charitable organization's population.

15. The method of claim 14 further comprising, increasing the score when a level of the diversity of employees in the organization and/or a level of the diversity of the recipients of the charitable organizations funds is at or above a pre-determined threshold level and decreasing the score when the level of the diversity of employees in the organization and/or the level of the diversity of the recipients of the charitable organizations funds is below the pre-determined threshold level.

16. The method of claim 13 wherein the plurality of digital portals further comprises a third tier of digital portals with a third level of oversight configured to provide the charitable organization with unrestricted access to the funds.

17. The method of claim 15 wherein, when the score assigned to the charitable organization is above the pre-determined threshold level, the method further comprises increasing the funds being transferred to the charitable organization.

18. The method of claim 13, wherein following transfer of the funds to the charitable organization, the method further comprises analyzing, periodically, the diversity of employees in the organization and the diversity of the recipients of the charitable organizations funds.

19. The method of claim 18 further comprising adjusting the score of the charitable organization based on the periodic performance of the analysis and in the event of a change in the score, the method further comprises changing the allocation of the digital portal for the charitable organization for a subsequent request of a donation from the charitable organization.

20. The method of claim 13 wherein the database is a distributed ledger, the distributed ledger comprising electronic data records and the updating the distributed ledger comprises, recording on a record, for each transaction:
the requested funds;
identification information of the charitable organization;
the funds transferred to the organization; and
the digital portal assigned to the organization.
